(19) United States
(12) Patent Application Publication
(10) Pub. No.: US 2006/0185781 A1
(43) Pub. Date: Aug. 24, 2006

(54) Apparatus and method for rejecting labels

(76) Inventor: Daniel McLaughlin, Homeworth, OH (US)

Correspondence Address: HAHN LOESER & PARKS, LLP, One GOJO Plaza, Suite 300, AKRON, OH, 44311-1076, US

(21) Appl. No.: 11/358,378

(22) Filed: Feb. 21, 2006

Related U.S. Application Data
(60) Provisional application No. 60/654,724, filed on Feb. 18, 2005.

(51) Int. Cl. B65C 9/42; B32B 38/00; B65C 9/26; B65C 9/28; B65C 9/36

(52) U.S. Cl. 156/64; 156/541; 156/378; 156/DIG. 1; 156/DIG. 37; 156/DIG. 38; 156/DIG. 42; 156/DIG. 45

(57) ABSTRACT

A radio frequency identification (RFID) label applicator comprising a label web path having a bend, the bend having an apex and a label-separating/label-retaining portion having an extendable acute label-separating edge, the path being directed about the portion at the bend so that the edge forms the apex of the bend into an acute apex when the edge is substantially extended, and when the edge is substantially retracted the apex is obtuse.

This application claims priority from provisional patent application Ser. No. 60/654,274, filed Feb. 18, 2005, the disclosure of which is hereby incorporated by reference.

### BACKGROUND OF THE INVENTION

Radio frequency identification (RFID) tags have recently become a preferred means of automatic identification as costs of production have declined. RFID tags store user-defined information and transmit that information to a reader, or data processor, via radio frequency (RF) waves. RFID tags may also allow the reader/processor to write new information thereto. Active RFID tags generally comprise a programmable microchip, an antenna, and a power source. Passive RFID tags do not contain an internal power source, and instead rely on RF (electromagnetic) waves sent from the reader/processor for power. The microchip stores data, while the antenna receives and transmits data as RF waves.

RFID labels contain RFID tags, in addition to having an exterior surface for receiving visible or printed markings. Therefore, RFID labels contain two forms of information, the RFID tag and the label surface. Within the label applicator industry, the use of RFID labels has created new problems. One of these problems is how to effectively perform read/write cycles on specified RFID labels efficiently and without adversely affecting other RFID labels. A second problem is how to reject defective RFID labels without significantly delaying label application cycles. The present invention at least provides a novel solution to these problems.

### SUMMARY OF THE INVENTION

In one embodiment, the invention comprises a radio frequency identification (RFID) label applicator, comprising: a label-separating/label-restraining portion having an acute label-separating edge; a label web path having a label separating/retaining bend, the bend being directed about the label-separating/label-restraining portion; wherein the edge is translatable between a first position and a second position such that when the edge is in the first position the bend is directed about the portion in an acute course, and when the edge is in the second position the label web path is directed about the portion in a obtuse course.

In another embodiment, the invention comprises a radio frequency identification (RFID) label applicator, comprising: a label-separating/label-restraining portion having an acute label-separating edge and an obtuse label-retaining surface; a label web path having a label separating/retaining bend, the bend being directed about the label-separating/label-restraining portion; wherein one of the edge and surface is translatable between a first and second position such that when the one of the edge and surface is in the first position the bend is acute and when the one of the edge and surface is in the second position the bend is obtuse.

In another embodiment, the invention comprises a radio frequency identification (RFID) label applicator, comprising: a label web path having a label separating/retaining bend; means for selectively separating a label from a label web at the bend, the means comprising an acute edge; and means for selectively retaining a label upon the label web at the bend, said retaining means providing an obtuse bend.

In another embodiment, the invention comprises a method of accepting or rejecting a radio frequency identification (RFID) label in a RFID label applicator, the method comprising the steps of: translating a target label contained upon a label web into a label processing unit, the unit being adjacent a label-separating/label-restraining portion about which the label web travels, where the portion includes an acute label-separating edge that forms an acute bend in the label web as it translates about the portion when the edge is in a label web engaging position, the label web having an obtuse bend about the portion when the edge is in a label web unengaged position; determining whether or not to use the target label; rejecting the target label after determining to not use the label by disengaging the label-separating edge prior to the label translating about the portion so the label web contains the obtuse bend thereabout; accepting the target label after determining to use the label by engaging the acute label-separating edge prior to the label translating about the portion so the label web contains the acute bend thereabout; and translating a portion of the label web adjacent the target label about the edge.

In another embodiment, the invention comprises a method of accepting or rejecting a radio frequency identification (RFID) label in a RFID label applicator, the method comprising the steps of: translating a target label contained upon a label web into a label processing unit, the unit including a retractable acute label-separating edge about which the label web translates in an acute course, so to generate separation forces between the web and any label translating about the edge capable of separating any label from the web; determining whether or not to use the target label; rejecting the target label after determining to not use the label by retracting the label-separating edge prior to the target label translating about the edge so to reduce the existence of any separation forces that may occur as the target label passes about the edge; accepting the target label after determining to use the label by extending the acute label-separating edge so to generate the necessary separation forces to cause the label to separate from the label web as the web translates about the edge; and translating a portion of the label web adjacent the target label about the edge.

### BRIEF DESCRIPTION OF THE DRAWINGS

FIG. 1 is a side view of a label applicator in accordance with a first embodiment of the present invention.

FIG. 2 is a top view of the label applicator shown in FIG. 1.

FIG. 3 is a side view of a snorkel unit in accordance with the first embodiment of the present invention.

FIG. 4 is a top view the snorkel unit shown in FIG. 3.

FIG. 5 is a front view of the snorkel unit shown in FIG. 3.

FIG. 6 is a side view of a label processing unit in accordance with the first embodiment of the present invention.

FIG. 7 is a top view of the label processing unit shown in FIG. 6.

FIG. 8 is a side view showing the snorkel unit in operation.

FIG. 9 is a side view showing the snorkel unit ejecting a label.

FIG. 10 is a side view showing the snorkel unit transferring a label to the applicator unit.

FIG. 11 is a side view showing the snorkel unit and applicator unit in operation.

### DETAILED DESCRIPTION OF THE PREFERRED EMBODIMENTS

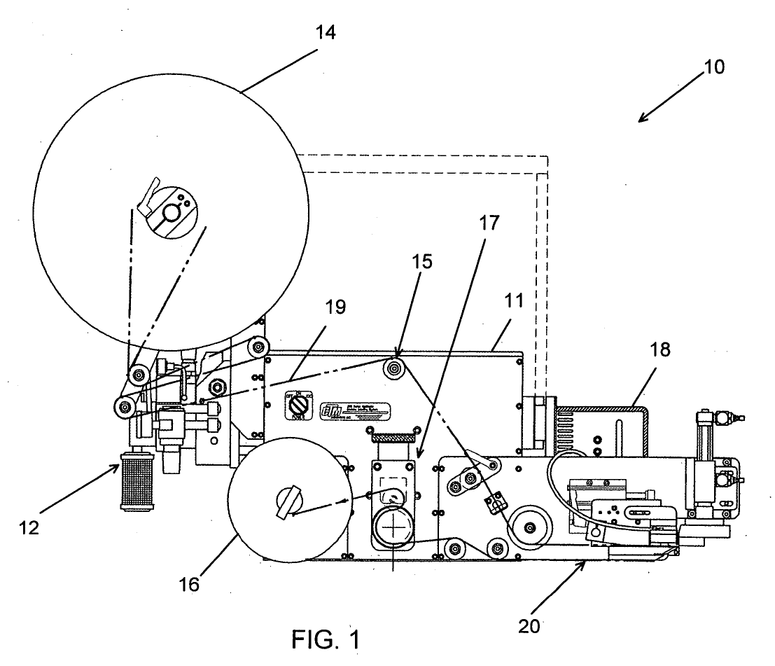

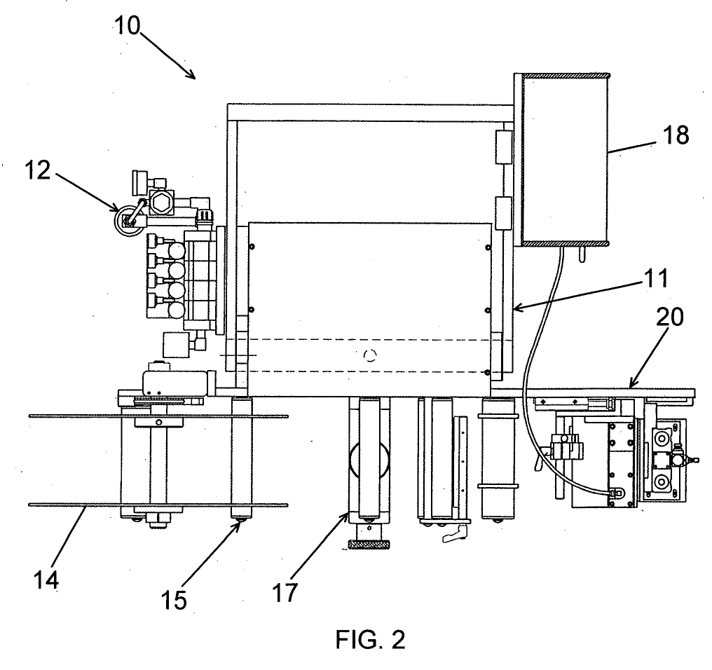

In FIGS. 1 and 2, a label applicator 10 is shown. Label applicator 10 generally includes the following components: a core unit 11; a valve unit 12; a supply spool 14, a tensioning spool array 15, a retrieval spool 16, a motor 17, a read/write unit 18, and a snorkel unit 20. Core unit 11 generally houses a controller, connectors to a power source and an air source, and data ports. The valve unit 12 generally provides pneumatic controls for certain label applicator operations, such as label application and rejection via snorkel unit 20. Supply spool 14 contains a label web 19, on which includes RFID labels 99 (not shown). Label web 19 travels through tensioning spool array 15, through snorkel unit 20, and returns to retrieval spool 16. Tensioning spool array 15 utilizes existing tensioning technology to ensure proper presentation and translation of label web 19. Motor 17 facilitates translation of label web 19 through label applicator 10. Read/write unit 18 communicates with RFID labels 99 via an antenna included within snorkel unit 20 for the purpose of reading from and writing to the RFID labels 99, verifying operational or active labels 99 and rejecting defective or improper labels 99, activating passive RFID labels 99, and storing data. The read/write unit 18 also processes data and/or commands. Read/write unit 18 will reject a RFID label 99 based on user-defined criteria, such as when: the read/write unit 18 fails to receive a response from the RFID label 99; the read/write unit 18 fails to receive any transmission from the RFID label 99; the RFID label 99 does not contain necessary user-defined information; or the read/write unit is unable to write to the RFID label 99. Although not necessary, read/write unit 18 transmits RF waves through an antenna at different power levels during read and write cycles because the power required for optimal read cycle performance is different than that required for optimal write cycle performance. Finally, snorkel unit 20 carries out many operations, including communicating with RFID labels 99 via an antenna contained therein, dispersing RFID labels 99 from label web 19 for application to products, applying RFID labels 99 to products, and ejecting rejected RFID labels 99 by failing to disperse the label 99 for product application. Core unit 11, valve unit 12, supply spool 14, tensioning spool array 15, retrieval spool 16, and motor 17 utilize technology well-known in the respective art and comprise any commercially available product thereof. Further, the location of all above-mentioned components within label applicator 10 are not critical to the current invention, except that the components must be arranged so that the collective continues to function as a label applicator. FIGS. 1 and 2 depict one of many possible arrangements of the above-mentioned components.

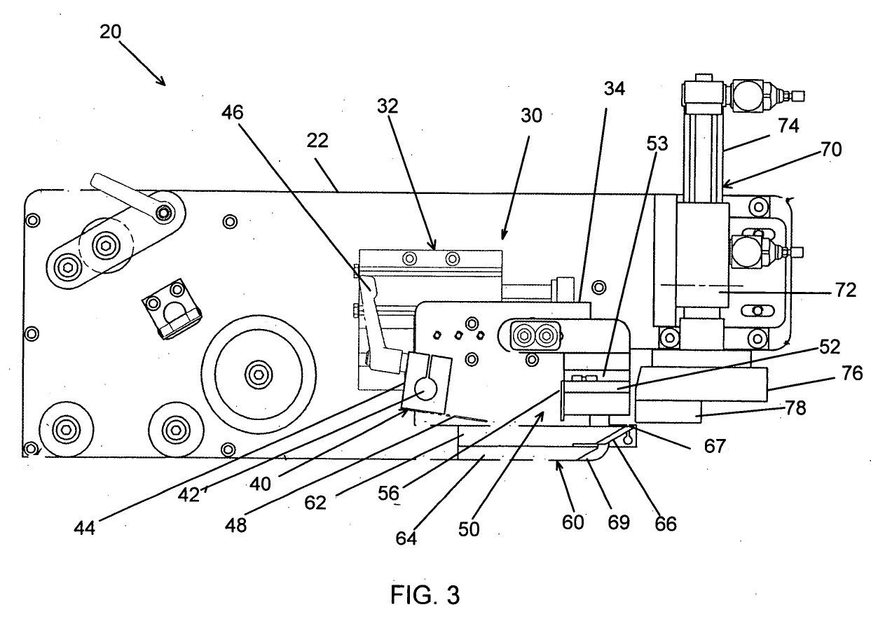

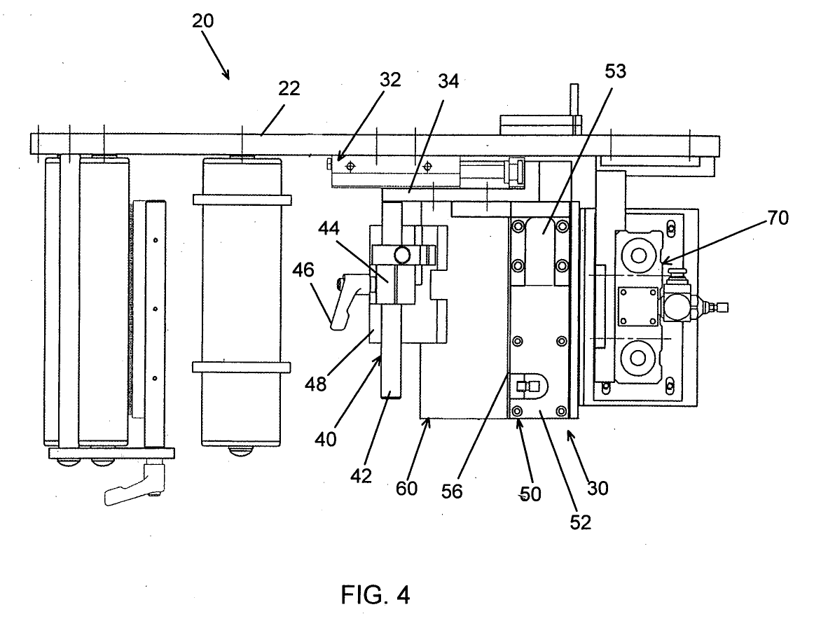

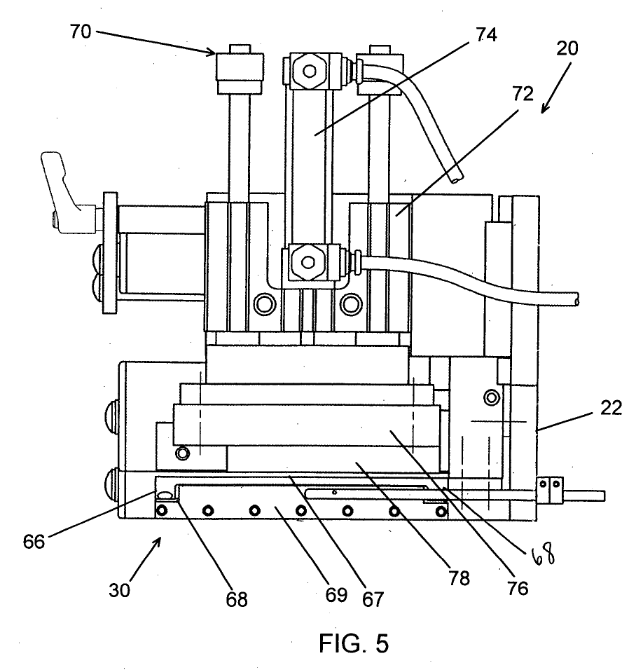

Referring to FIGS. 3 through 5, snorkel unit 20 includes a snorkel base 22, label processing unit 30, and a label applicator unit 70. Snorkel base 22 provides a surface to mount processing unit 30 and applicator unit 70. Generally, processing unit 30 provides an antenna unit 54 (not shown) that allows read/write unit 18 to communicate with RFID labels 99. After communicating with a RFID label 99, processing unit 30 then either extracts an operational label 99 from label web 19 and delivers it to applicator unit 70 or leaves a rejected label 99 on web 19 for return to retrieval spool 16 (also referred to as label ejection). After receiving an operational label 99, label applicator unit 70 temporarily retains the label 99 and subsequently transfers the label 99 to any desired product. While label applicator unit 70 is receiving and applying the operational label 99, a new RFID label 99 is drawn into position below antenna 54, verified operational or rejected, ejected if verified a rejected label 99, and, if desired, has data written thereto. Thus, the new RFID label 99 may be ready for delivery to applicator unit 70 immediately after applicator unit 70 applies the previously transferred label 99 to the product, depending on the user-defined operations to be performed on the new RFID label 99 by the read/write unit 18. By allowing the read/write unit 18 to operate on a label 99 while another is being applied to a product, the time extending between label applications is reduced.

The label processing unit 30 includes an ejector slide unit 32, a spring block unit 40, an antenna unit 50, and a peel unit 60. Ejector slide unit 32 provides a sliding mounting portion 34 that translates, thereby allowing a portion of the peel unit 60 to retract and eject a rejected label 99. Ejection allows a rejected label 99 to remain on label web 19 as it returns to retrieval spool 16, instead of transferring the label 99 from peel unit 60 to applicator unit 70, as with an operational label 99. It is contemplated that other orientations may exist that would require mounting portion 34 to translate in different directions to effect label ejection, including rotational translations. Ejector slide unit 32 mounts to the snorkel base 22.

Spring block unit 40 ensures proper label web 19 alignment and tension along top plate 62 and comprises a rod 42, a block 44 with securement means 46, and a spring plate 48. In the present embodiment, rod 42 attaches to mounting portion 34; however, it is contemplated that it could mount elsewhere, such as to top plate 62. Block 44 translates axially and radially about rod 42, allowing spring plate 48 to track the location of label web 19 and conform to the thickness of label web 19. Block 44 includes a securing means 46 for constraining block 44 to rod 42. In the present embodiment, the securing means 46 comprises a levered screw, although it is contemplated that any commercially available means may be used. Spring plate 48 attaches to block 44. By properly positioning and securing block 44, spring plate 48 applies pressure to label web 19 so to assist in constraining label web 19 as it approaches the antenna unit 50 and the peel unit 60. Spring plate 48 is made of acetal resin, such as DuPont's Delrin®, or any comparable commercially available material that does not interfere with RF waves. This provides more consistent read/write cycles between antenna 54 and the RFID labels 99, since the use of bare metal interferes with those cycles. It is contemplated that insulated metal may also be used. Rod 42, block 44, and securing means 46 may be formed of any commercially available material, whether metal or non-metal.

Antenna unit 50 transmits and receives RF waves from a RFID label 99 and comprises an antenna housing 52, an antenna 54 (not shown), and an insulating plate 56. In the present embodiment, antenna unit 50 attaches to mounting portion 34; however, it is contemplated that antenna unit 50 may mount elsewhere, such as to top plate 62. Antenna housing 52 generally protects antenna 54 from physical damage by enclosing antenna 54 therein. In the present embodiment, antenna housing 52 is made of acetal resin. such as Delrin®, or any comparable material available commercially that does not interfere with RF signals sent to or from antenna 54. Because proper RF transmission to and from antenna 54 generally requires, based on the present embodiment, non-metallic material to be no closer than approximately one-half inch (½″) from antenna 54, a spacer made from acetal resin, or any other comparable material, may be required when attaching housing 52 to mounting portion 34. The location of metallic material in relation to antenna 54 may change as stronger or weaker RF waves are transmitted from antenna 54, thereby allowing metallic materials to be closer than or requiring metallic materials to be farther than one-half inch (½″) from antenna 54. Insulating plate 56 secures to the label web 19 upstream side (or the block 44 side) of antenna housing 52, to prevent approaching RFID labels 99 from being adversely affected by RF waves sent between antenna 54 and the intended RFID label 99 (generally closest to antenna 54). In the present embodiment, insulating plate 56 is made of stainless steel; however, it is contemplated that any other reflective material may be used. Antenna 54 comprises any commercially available RF antenna, such as those supplied by SAMSys Technologies Inc.

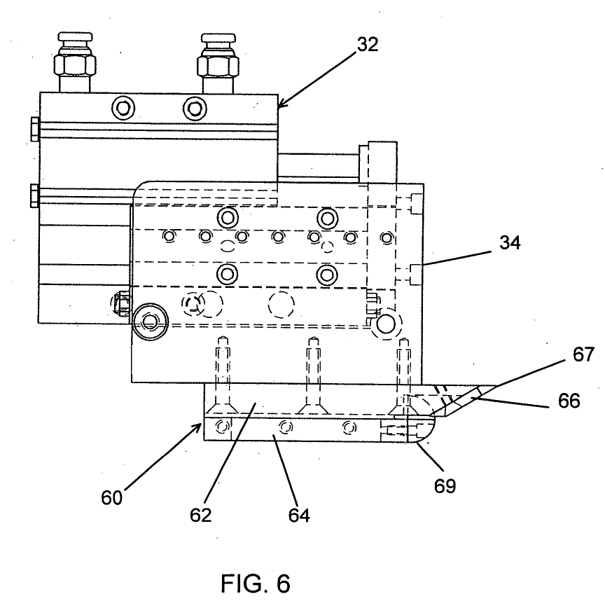

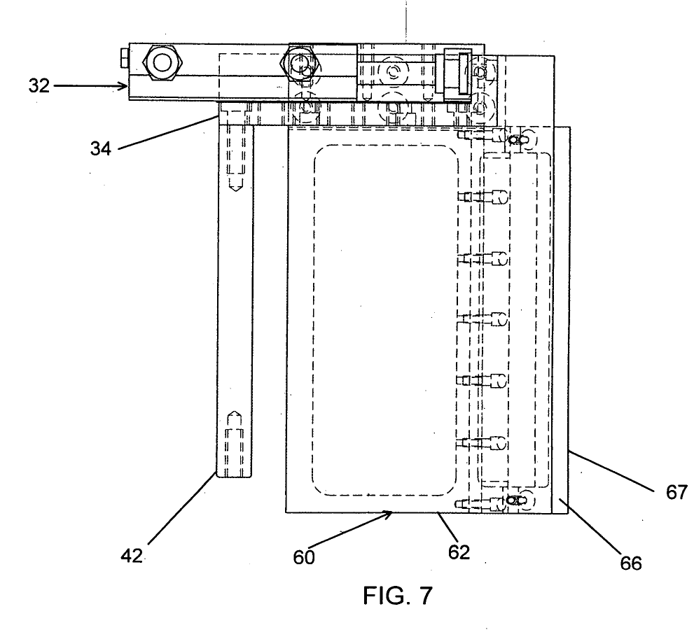

Referring to FIGS. 6-7, peel unit 60, generally, initiates the physical portion of the label application and ejection processes and comprises top plate 62, bottom plate 64, peel plate 66, peel edge 67, and return edge 69. If read/write unit 18 determines a label 99 operational, the label 99 is separated from label web 19 at peel edge 67 and transferred to application unit 70 for product application. Tensile forces arising between the label 99 and the label web backing cause the label 99 to separate from label web 19 at peel edge 67, due to the high return angle (the acute course or bend) experienced by label web 19 as it navigates around peel edge 67 toward retrieval spool 16. If read/write unit 18 determines a label 99 is defective or otherwise rejected, the label 99 remains on label web 19 by retracting top plate 62. This provides a more gradual (obtuse) path around peel edge 67, thereby avoiding the separation forces associated with a high return angle. In the present embodiment, top plate 62 attaches to mounting portion 34 below spring plate 48 and antenna unit 50; however it is contemplated top plate 62 may mount elsewhere, such as to antenna unit 50, and above spring plate 48 and antenna unit 50. Further, top plate 62 is made of acetal resin, such as Delrin , or any comparable material available commercially that does not interfere with RF signals. In the present embodiment, top plate 62 thickness is approximately one-half inch (½″) to prevent RF signal interference resulting from signal reflections, as seen at higher thicknesses; however, it is contemplated that different thickness may be required based upon the material used and/or the existing RF system (having different RF wave frequencies and amplitudes).

Peel plate 66 attaches to at least a portion of the top plate 62 and is located along a top edge and adjacent side thereof, where the downstream portion of the RFID web travels after passing antenna unit 50 (typically located nearest the label applicator unit 70). Any commercially available means of attachment may be used, including fasteners and clips. The purpose of peel plate 66 is to provide a replaceable wear part, since the label web 19 travels over and around the uppermost portion thereof, of which at least includes the peel edge 67. In the present embodiment, the side portion of top plate 62 adjacent peel plate 66 is chamfered or angled (linearly or arced) inward from the uppermost portion of the top plate 62; although it is contemplated that peel plate 66 may comprise a triangular-like cross-section in an effort to duplicate the present profile formed by top plate 62 with peel plate 66. The purpose of the angled side is to provide a high angle of return (an acute course or bend) for label web 19 (generally more than ninety degrees (90° )) about peel edge 67 for separating labels 99 from label web 19. Peel plate 66 generally has a trapezoidal cross-sectional shape, thereby facilitating its mounting to top plate 62 while maintaining an uppermost surface that is substantially co-planar with the uppermost surface of top plate 62. Peel edge 67 may include mounting flanges 68, which extend further along the mounting side of top plate 62. The inclusion of flanges 68 facilitates the reduction of material in the remaining portions of peel plate 66, thereby minimizing RF signal reflection (interference). In the present embodiment, peel plate 66 is made from stainless steel for its wear properties; however, it is contemplated that peel plate 66 may be made from any other comparable metal or non-metal material. It is also contemplated that the cross-sectional shape of peel plate 66 may be non-trapezoidal and the peel plate 66 may mount to the uppermost surface of top plate 62.

Bottom plate 64 attaches to snorkel base 22 below and in close proximity to top plate 62, for the purpose of providing support thereto. It is contemplated that bottom plate 64 may mount elsewhere, such as to the stationary portion of slide unit 32. In the present embodiment, bottom plate 64 is made of aluminum; however, it is contemplated that different materials may be used, such as steel or acetal resin. The aluminum bottom plate 64 comprises a frame having an open center, for the purpose of minimizing RF reflection, and is approximately three-eighths of an inch (⅜″) thick; however, different designs and thicknesses may be required or allowed based upon the material used and/or the existing RF system (having different RF wave frequencies and amplitudes). A return edge 69 attaches to a side of bottom plate 64 substantially adjacent to peel edge 67, so to contact label web 19 after translating from peel edge 67. Return edge 69 is rounded and made of acetal resin, such as Delrin®, or any other comparable material available commercially. This minimizes damage to label web 19 by providing a low-friction surface for improved translation as web 19 exits peel edge 67, around bottom plate 64 and toward retrieval spool 16.

Once a label 99 is separated from the label backing at the peel edge 67, it travels to the applicator unit 70 (referring again to FIGS. 3-5). In the present embodiment, applicator unit 70 utilizes a tamp blow application method; however, it is contemplated that merge or air-blow application methods may be used. The tamp applicator unit 70 includes tamp slide mechanism 72, actuator (or cylinder) 74, manifold 76, and label pad 78. Tamp slide mechanism 72 provides a unit that translates in response to actuator 74, and to which manifold 76 mounts. Manifold 76 provides a vacuum that allows attached label pad 78 to grasp a label 99 as it separates from the label web backing at peel edge 67. While label pad 78 grasps the label 99, actuator 74 directs label pad 78 via tamp slide mechanism 72 toward the to-be-labeled product. Applicator unit 70 then applies the label 99 retained by label pad 78 by terminating the vacuum and then blowing the label 99 against the product. In the present embodiment, a product sensor initiates actuator 74 and/or the termination of the vacuum and creation of the blow operation. In use, the product sensor may initiate actuator 74, terminate vacuum, and blow sequentially as stated above. Also, actuator 74 may extend to a predefined length without receiving any signal from the product sensor, which then only requires product sensor to initiate termination of the vacuum and generation of the blow operation. It is contemplated that any commercially available applicator unit 70 may be used, except that label pad 78 is to be made of aluminum, or any other comparable metal or metal composite that prevents RF waves from adversely affecting the label 99 grasped by label pad 78. It is further contemplated that applicator unit 70 may include either actuator 74 or the blow operation, without the other.

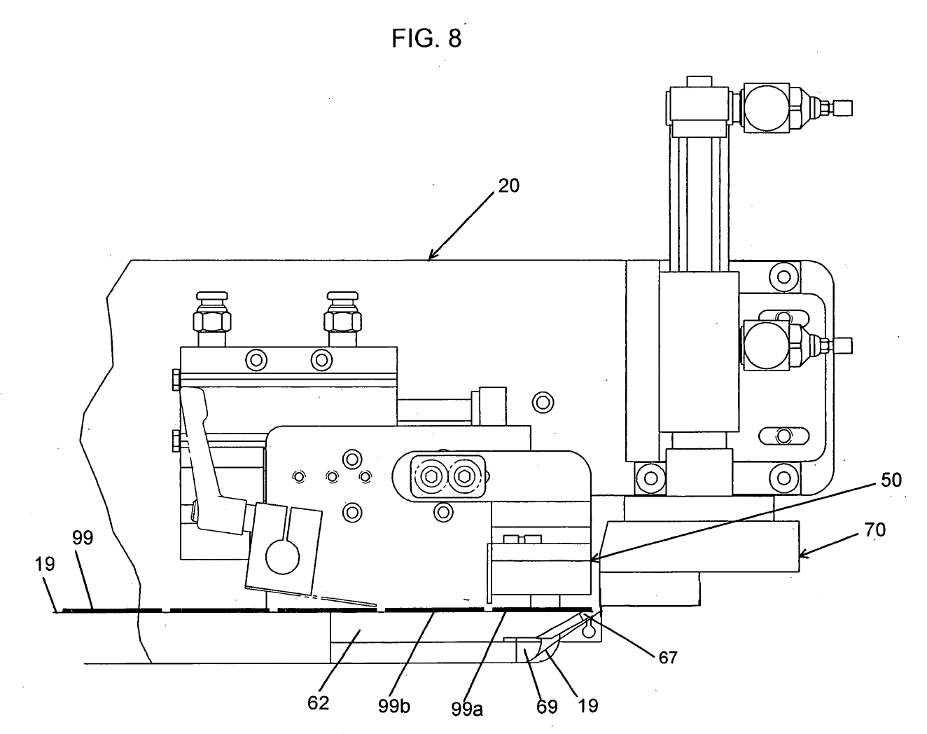

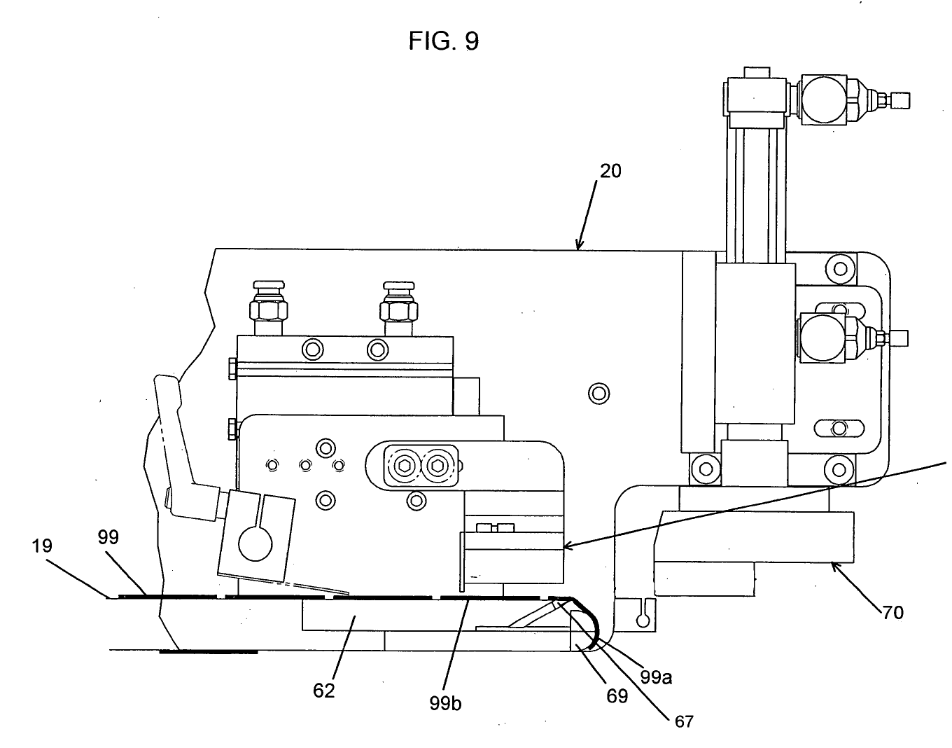

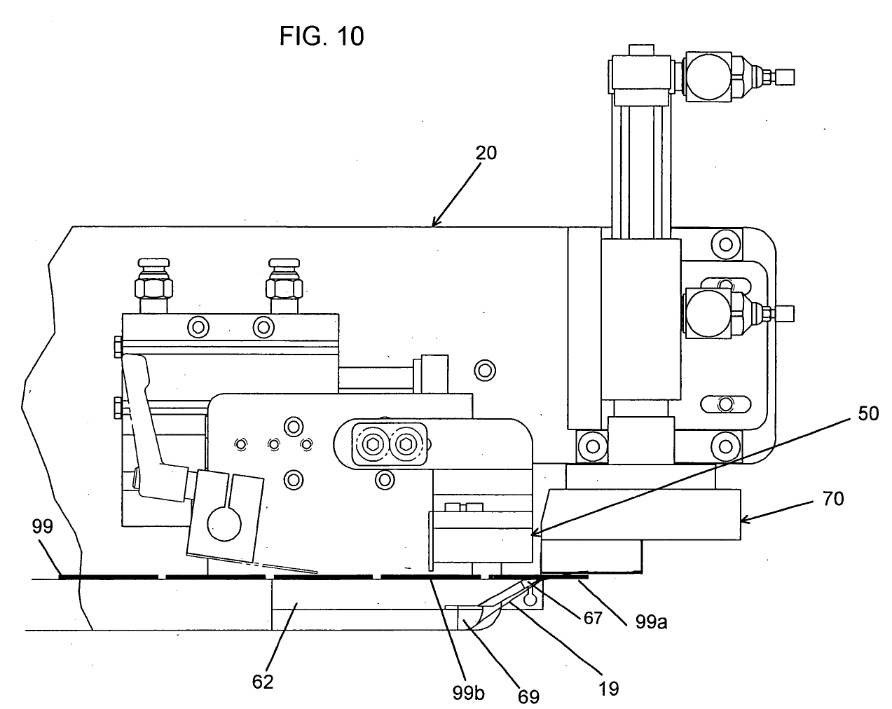

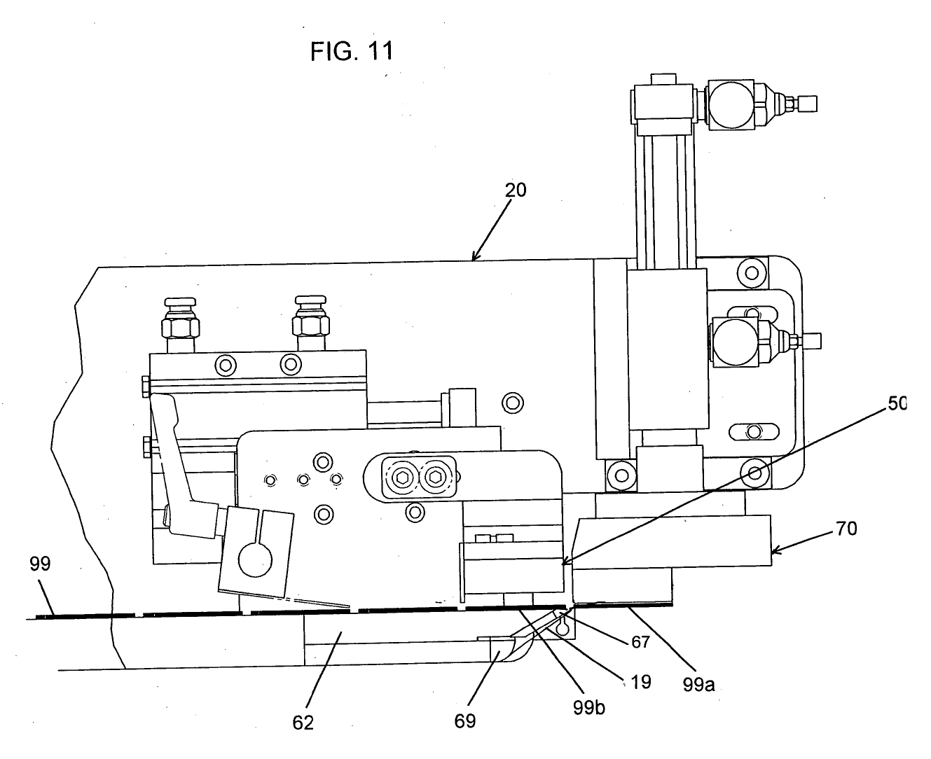

FIGS. 8-11 show the operation of label applicator 10, and more specifically the progression of label web 19 and RFID labels 99 through the snorkel unit 20. In operation, and after entering snorkel unit 20, label web 19 translates upon the top plate 62 of peel unit 60 to place a label 99a below antenna unit 50 (FIG. 8). At this time, any read/write operations are performed on label 99a. After all read/write operations are complete, label web 19 continues to translate upon top plate 62 toward peel edge 67. As a label 99 approaches peel edge 67, the read/write unit 18 has already determined whether label 99a is to be applied to a product or whether label 99a is to be ejected. If label 99a is to be ejected (FIG. 9), top plate 62 slides away from the applicator unit 70 (in the label web 19 upstream direction), thereby allowing label web 19 to continue to travel toward applicator unit 70 at a decreasing angle (in an obtuse course or bend) until reaching return edge 69, whereupon the label web 19 travels around toward retreival spool 16. This course of travel reduces separation stresses (primarily tensile) within the adhesive between label 99a and label web 19, thereby allowing label 99a to remain on label web 19 as it returns to retrieval spool 16. As the ejected label is removed from top plate 62, another label 99b is being placed underneath antenna unit 50 to begin the same process. If label 99a is operational (FIGS. 10-11), label web 19 proceeds over and about peel edge 67, leaving peel edge 67 in a downward direction (in an acute course or bend) away from applicator unit 70. This provides separation stresses (primarily tensile) within the adhesive between label 99a and label web 19, sufficient to separate label 99a from label web 19. Applicator unit 70 then obtains label 99a for its application to a product. As label 99a is being transferred to applicator unit 70, label 99b is being placed into position under antenna unit 50 to begin the same process. While applicator unit 70 is applying label 99a to a product, read/write operations may begin to reduce any delay in translating label 99b after application of label 99a. Note, the read/write operations upon a label 99 may begin before a label 99 is completely under antenna unit 50 (or as label 99 translates towards antenna unit 50) and may continue as label 99 translates away from antenna unit 50.

Although the present invention has been described above in detail, the same is by way of illustration and example only and is not to be taken as a limitation on the present invention.

I claim the following:

1. A radio frequency identification (RFID) label applicator, comprising:
a label-separating/label-restraining portion having an acute label-separating edge;
a label web path having a label separating/retaining bend, the bend being directed about the label-separating/label-restraining portion;
wherein the edge is translatable between a first position and a second position such that when the edge is in the first position the bend is directed about the portion in an acute course, and when the edge is in the second position the label web path is directed about the portion in a obtuse course.

2. The label applicator recited in claim 1, further comprising an obtuse label-retaining surface that substantially forms the obtuse course.

3. The label applicator as recited in claim 2, wherein the obtuse surface comprises a curved surface.

4. The label applicator as recited in claim 3, wherein the first position is an extended position of the label-separating/label-restraining portion relative the second position and the obtuse label-retaining surface.

5. The label applicator recited in claim 1, wherein the acute course directs the path about the edge by at least two-hundred and seventy degrees (270°).

6. The label applicator recited in claim 1, wherein the label-separating/label-retaining portion includes a label-separating plate having a top surface and an end-side surface, the label separating edge being located at a corner of the plate formed by the convergence of the top surface and an end side surface.

7. The label applicator recited in claim 6, wherein the label-separating/label-retaining portion includes a top plate having a side-end to which the label-separating plate operably attaches.

8. The label applicator recited in claim 7, wherein the label-separating/label-retaining portion includes a base substantially adjacent the top plate.

9. The label applicator recited in claim 8, wherein the base extends substantially parallel to the top plate and comprises a frame that extends about a perimeter of the base such that the base is void of any material adjacent a central portion of the top plate.

10. The label applicator recited in claim 8, wherein the label-retaining surface is a portion of a label web pivot, the pivot operably attaching to the base.

11. The label applicator recited in claim 1, further comprising an RFID label processing area and an RFID antenna located in operable proximity to the processing area, wherein the label web path enters the processing area from a label web upstream direction.

12. The label applicator recited in claim 11, wherein the RFID label processing area is located adjacent the top plate.

13. The label applicator recited in claim 12, further comprising a label isolation plate located on the web upstream side of the antenna, the plate made of a radio frequency reflective material.

14. The label applicator recited in claim 1, further comprising a label application unit located substantially adjacent the label-separating edge.

15. The label applicator recited in claim 14, wherein the application unit is either a tamp blow, merge, or air-blow unit.

16. The label applicator as recited in claim 1, wherein the acute edge extends from the portion when the edge is in the first position.

17. A radio frequency identification (RFID) label applicator, comprising:
a label-separating/label-restraining portion having an acute label-separating edge and an obtuse label-retaining surface;
a label web path having a label separating/retaining bend, the bend being directed about the label-separating/label-restraining portion;
wherein one of the edge and surface is translatable between a first and second position such that when the one of the edge and surface is in the first position the bend is acute and when the one of the edge and surface is in the second position the bend is obtuse.

18. A radio frequency identification (RFID) label applicator, comprising:
a label web path having a label separating/retaining bend;
means for selectively separating a label from a label web at the bend, the means comprising an acute edge; and
means for selectively retaining a label upon the label web at the bend, said retaining means providing an obtuse bend.

19. A method of accepting or rejecting a radio frequency identification (RFID) label in a RFID label applicator, the method comprising the steps of:
translating a target label contained upon a label web into a label processing unit, the unit being adjacent a label-separating/label-restraining portion about which the label web travels, where the portion includes an acute label-separating edge that forms an acute bend in the label web as it translates about the portion when the edge is in a label web engaging position, the label web having an obtuse bend about the portion when the edge is in a label web unengaged position;
determining whether or not to use the target label;
rejecting the target label after determining to not use the label by disengaging the label-separating edge prior to the label translating about the portion so the label web contains the obtuse bend thereabout;
accepting the target label after determining to use the label by engaging the acute label-separating edge prior to the label translating about the portion so the label web contains the acute bend thereabout; and
translating a portion of the label web adjacent the target label about the edge.

20. The method of accepting or rejecting a label as recited in claim 19, wherein the method of rejecting includes engaging an obtuse label-retaining surface upon the label web so to form an obtuse bend in the web as the web translates about the portion, the surface being a part of the portion.

21. The method of accepting or rejecting a label as recited in claim 20, wherein the step of determining includes reading the target label via an antenna, the label being a radio frequency identification (RFID) label.

22. A method of accepting or rejecting a radio frequency identification (RFID) label in a RFID label applicator, the method comprising the steps of:
translating a target label contained upon a label web into a label processing unit, the unit including a retractable acute label-separating edge about which the label web translates in an acute course, so to generate separation forces between the web and any label translating about the edge capable of separating any label from the web;
determining whether or not to use the target label;
rejecting the target label after determining to not use the label by retracting the label-separating edge prior to the target label translating about the edge so to reduce the existence of any separation forces that may occur as the target label passes about the edge;
accepting the target label after determining to use the label by extending the acute label-separating edge so to generate the necessary separation forces to cause the label to separate from the label web as the web translates about the edge; and
translating a portion of the label web adjacent the target label about the edge.
